(19) United States
(12) Patent Application Publication
(10) Pub. No.: US 2015/0035214 A1
(43) Pub. Date: Feb. 5, 2015

(54) HOLDING DEVICE

(71) Applicants: FU DING ELECTRONICAL TECHNOLOGY (JIASHAN) CO.,LTD., Zhejiang (CN); HON HAI PRECISION INDUSTRY CO., LTD., New Taipei (TW)

(72) Inventors: HUA ZHANG, Jiashan (CN); HAI-HE XUE, Jiashan (CN)

(21) Appl. No.: 14/444,572

(22) Filed: Jul. 28, 2014

(30) Foreign Application Priority Data
Jul. 31, 2013 (CN) 2013204628330

(51) Int. Cl. B23Q 3/06; B23Q 3/08

(52) U.S. Cl. CPC B23Q 3/065; B23Q 3/08
USPC 269/25

(57) ABSTRACT

A holding device includes a main body defining a channel, a supporting assembly coupled to the main body, a plurality of pistons positioned on the main body, and an adjusting assembly positioned in the main body. The substance channel includes a main channel and a plurality of first sub-channels defined from a side of the main channel and communicating with an outside. An end of each piston received in a corresponding first sub-channel, the other end coupling to the supporting assembly. The adjusting assembly is received in an end of the main channel capable of being inserted into the main channel. The plurality of pistons is configured to drive the supporting assembly to move away from the main body.

### FIELD

The present disclosure relates to holding devices, and particularly to a holding device configured to hold hollow workpieces.

### BACKGROUND

When a hollow workpiece with thin sidewalls, is being machined a holding piece must be inserted therein to keep deformities from occurring.

### BRIEF DESCRIPTION OF THE DRAWINGS

Implementations of the present technology will now be described, by way of example only, with reference to the attached figures, wherein:

FIG. 1 is an isometric view of an embodiment of a holding device.

FIG. 2 is a cross-sectional view of the holding device of FIG. 1, taken along a line II-II.

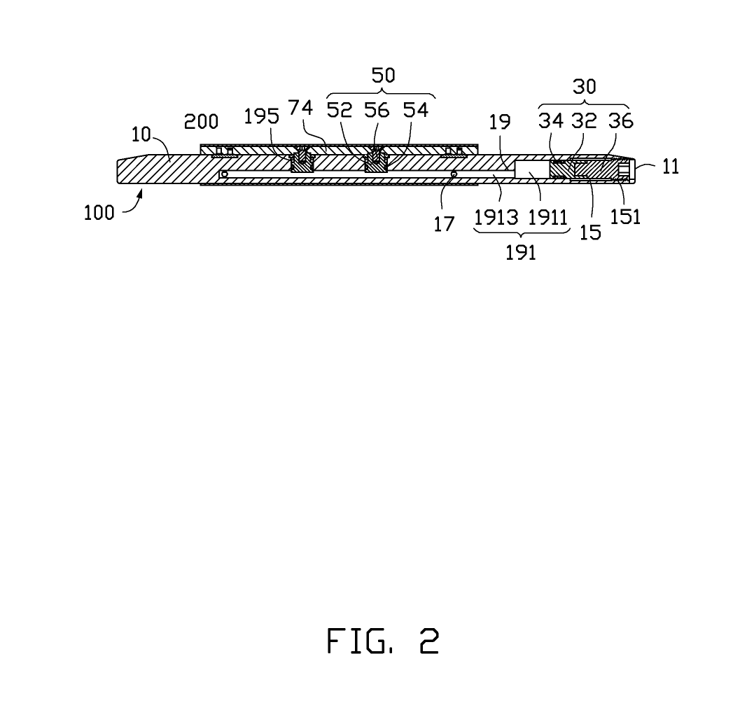

FIG. 3 is a cross-sectional view of the holding device of FIG. 1, taken along a line III-III.

FIG. 4 is an exploded, isometric view of the holding device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to holding devices, and particularly to holding devices configured to support hollow workpieces.

A holding device can include a main body defining a channel, a supporting assembly configured to be coupled to the main body, a plurality of pistons configured to be positioned on the main body, and an adjusting assembly positioned in the main body. The substance channel can include a main channel and a plurality of first sub-channels defined from a side of the main channel and fluidly communicate with outside. The plurality of pistons can be configured to move within a cylinder formed within the main body. An end of each piston can be received in a corresponding first sub-channel; the other end can be configured to be coupled to the supporting assembly. The adjusting assembly can be received in an end of the main channel capable of being inserted into the main channel. The plurality of pistons can be configured to drive the supporting assembly away from the may body.

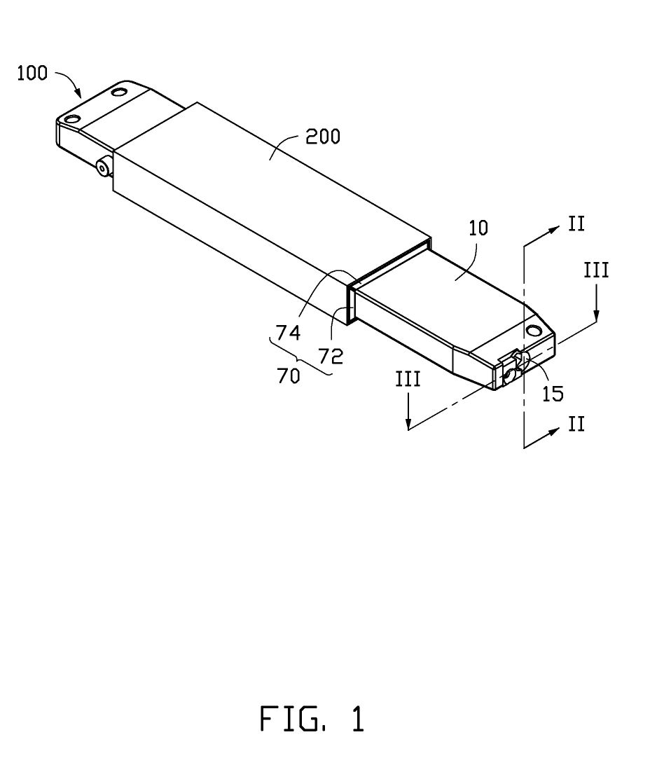

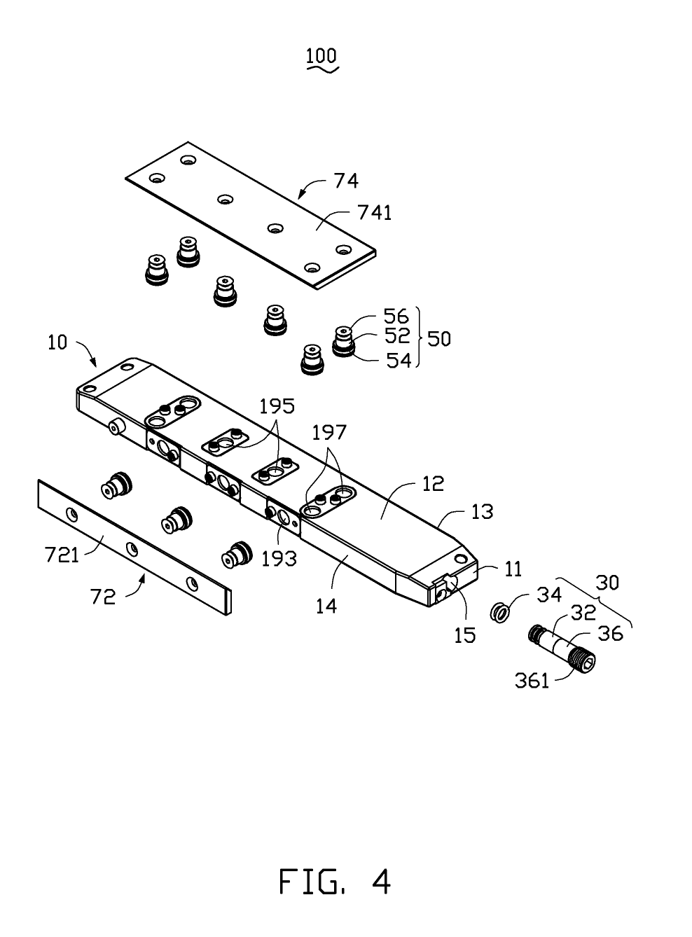

FIGS. 1 and 4 illustrate an embodiment of a holding device 100 arranged in a hollow workpiece 200 and configured to expand and enhance a strength of the hollow workpiece 200. The holding device 100 can include a main body 10, an adjusting assembly 30 positioned in the main body 10, a plurality of piston assemblies 50 positioned on the main body 10, and a supporting assembly 70 coupled with the plurality of piston assemblies 50. The holding device 100 can be received in the hollow workpiece 200, and the main body 10 can be filled with a substance (not labeled). The adjusting assembly 30 can press the substance and drive the piston assemblies 50 to move, which moves the supporting assembly 70 away from the main body 10, and pushes against an inside of the hollow workpiece 200, thereby holding and enhancing the strength of the workpiece 200. In at least one embodiment, the substance contained in the main body 10 can be hydraulic oil. In another embodiment, the substance can be other liquids or gas, for example.

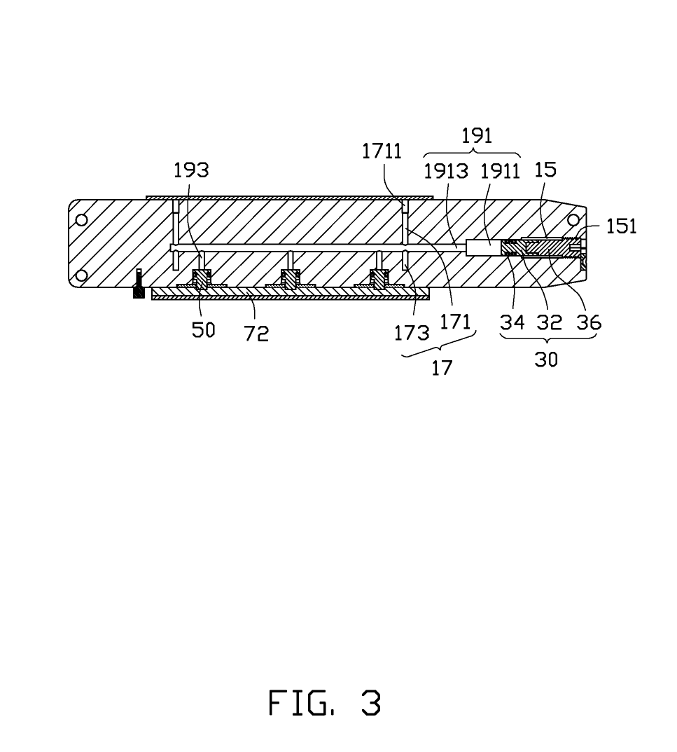

FIGS. 3 and 4 illustrate the main body 10 can be a rectangular block, and can include a end face 11, a top surface 12, a first sidewall 13, and a second sidewall 14. The end face 11 can be formed at an end of the main body 10. The top surface 12 can be adjacent and coupled to the end face 11. The first sidewall 13 and the second sidewall 14 can be positioned on opposite sides of the top surface 12, respectively, and the first sidewall 13 and the second sidewall 14 are parallel to each other and perpendicular to the top surface 12. A mounting hole 15 can be defined on the end face 11, and two draining holes 17 can be defined on the first side wall 13. A channel 19 can be defined in the main body 10. In the illustrated embodiment, a number of the draining holes 17 can be two. In another embodiment, a number of the draining holes 17 can be one or more than one. The mounting hole 15 can extend along a longitudinal direction of the main body 10 and can communicate with outside. A thread connecting portion 151 can be defined in the mounting hole 15, and can be configured to couple to the adjusting assembly 30. At least one of the two draining holes 17 can be defined on the first sidewall 13, and an axis of the at least one draining hole 17 can be perpendicular to the axis of the mounting hole 15. A plug 1711 can be positioned in each of the two draining holes 17 adjacent to the first sidewall 13, configured to seal the corresponding draining hole 17. The substance channel 19 can include a main channel 191, a plurality of first sub-channels 193, a plurality of second sub-channels 195, and a plurality of third sub-channels 197.

The main channel 191 can be defined on a bottom surface of the mounting hole 15, and an axis of the main channel 191 can extend along the longitudinal direction of the main body 10. The main channel 191 can include a receiving portion 1911 and a draining portion 1913, opposite ends of the mounting hole 15 can communicate with the receiving portion 1911 and the draining portion 1913, respectively. The receiving portion 1911 can be coaxial with the mounting hole 15, and a diameter of the receiving portion 1911 can be less than a diameter of the mounting hole 15. The draining portion 1913 can be defined on an end of the receiving portion 1911 away from the mounting hole 15. An axis of the draining portion 1913 can be parallel to the receiving portion 1911, and a diameter of the draining portion 1913 can be less than the diameter of the receiving portion 1911. The draining hole 17 can be perpendicular to the draining portion 1913, and can extend to cross the draining portion 1913. The draining hole 17 can include a draining end 171 adjacent to the first sidewall 13, and an extending end 173 extending from the draining portion 1913.

Each of the plurality of the first sub-channels 193 can be parallelly spaced from each other. Axes of the first sub-channels 193 can be perpendicular to the axis of the draining portion 1913. In the illustrated embodiment, a number of the first sub-channels 193 can be three. The three first sub-channels 193 can be positioned between the two draining holes 17. An end of each of the plurality of the first sub-channels 193 can communicate with the draining portion 1913, the other end can extend through the second sidewall 14 and communicate with outside. Each of the plurality of the second sub-channels 195 can be parallelly spaced from each other. Axes of the second sub-channels 195 can be perpendicular to the axis of the draining portion 1913 and axes of the first sub-channels 193. In the illustrated embodiment, a number of the second sub-channels 195 can be two. An end of each of the plurality of the second sub-channels 195 can communicate with the draining portion 1913, the other end can extend through the top surface 12 and communicate with outside.

The plurality of the third sub-channels 197 can be parallelly spaced from each other. Axes of the third sub-channels 197 can be parallel to the axes of the second sub-channels 193. In the illustrated embodiment, a number of the third sub-channels 197 can be four. Two of the four third sub-channels 197 can extend from the two draining ends 171 towards and through the top surface 12, respectively, and can communicate with the outside. The other two third sub-channels 197 can extend from the two extending ends 173 towards and through the top surface 12, respectively, and can communicate with the outside. The two second sub-channels 195 can be positioned between four third sub-channels 197. The first sub-channels 193, the second sub-channels 195, and the third sub-channels 197 can be used to receive the piston assemblies 50 and can be sealed by the piston assemblies 50. In another embodiment, the number of the first sub-channels 193, the number of the second sub-channels 195, and the number of the third sub-channels 197 can be one or more than one.

The adjusting assembly 30 can be positioned in the receiving portion 1911 and the mounting hole 15, and can seal an end of the receiving portion 1911. The adjusting assembly 30 can be capable of pressing the substance contained in the substance channel 19, and configured to adjust a pressure of the substance. The adjusting assembly 30 can include a plunger 32, at least one sealing ring 34 positioned on the plunger 32, and a pressing member 36 coupled to an end of the plunger 32.

The plunger 32 can be substantially a cylinder-shape. An end of the plunger 32 can be received in the receiving portion 1911; the other end can protrude into the mounting hole 15. The sealing ring 34 can be sleeved on the end of the plunger 32 and be received in the receiving portion 1911, and can resist against an inside surface of the receiving portion 1911 to seal the substance channel 19. The pressing member 36 can be slidably positioned in the mounting hole 15, and capable of moving in the mounting hole 15 relative to the main body 10. An end of the pressing member 36 can be inserted into the plunger 32. A pressing force generated by the pressing member 36 moving towards the substance in the substance channel 19 can be controlled. In the illustrated embodiment, the pressing member 36 can be a hexagon bolt. A connecting thread 361 can be defined on an end of the pressing member 36 away from the plunger 32. The connecting thread 361 can couple to the connecting portion 151 of the mounting hole 15. The pressing member 36 can drive the plunger 32 to press the substance in the substance channel 19 when the pressing member 36 is threaded into the main body 10.

Each of the plurality of the piston assemblies 50 can be movably received in each of the plurality of the first sub-channels 193, each of the plurality of the second sub-channels 195, and each of the plurality of the third sub-channels 197, respectively. Each of the plurality of the piston assemblies 50 can include a piston 52, a sealing member 54, and a fastener 56. A first end of the piston 52 can be received in the substance channel 19, and a second end of the piston 52 can extend out of the main body 10. The sealing member 54 can sleeve on the piston 52 and can be received in the substance channel 19. The sealing member 54 can resist against an inside surface of the substance channel 19 to seal the substance channel 19. The fastener 56 can be inserted into the second end of the piston 52 protruding from the main body 10. The fastener 56 can be used to interconnect the piston 52 and the supporting assembly 70.

The supporting assembly 70 can include a first supporting member 72 and a second supporting member 74. The first and second supporting members 72, 74 can be arranged around the main body 10 corresponding to the top surface 12 and the second sidewall 14. The first supporting member 72 can be substantially a rectangular strip. The first supporting member 72 can be positioned corresponding to the first sub-channels 193, and parallel to the second sidewall 14. The fasteners 56 can be inserted through the first supporting member 72 and couple to corresponding pistons 52 to secure the first supporting member 72 to corresponding piston 52. The first supporting member 72 can include a first supporting surface 721 departing from the main body 10. The first supporting surface 721 can be used to resist against and press an inside surface of the hollow workpiece 200. The second supporting member 74 can be substantially a rectangular plate, and can be positioned corresponding to the second sub-channels 195 and third sub-channels 197, parallel to the top surface 12. The fasteners 56 can be inserted through the second supporting member 74 and be coupled to the corresponding pistons 52. The second supporting member 74 can include a second supporting surface 741 departing from the main body 10. The second supporting surface 741 can be used to resist against and press an inside surface of the hollow workpiece 200. The first supporting member 72 and the second supporting member 74 can be driven by corresponding pistons 52 to move toward or away from the main body 10. In the illustrated embodiment, the first supporting member 72 can be secured to three of the plurality of pistons 52 received in the three first sub-channels 193, and the second supporting member 74 can be coupled to six of the plurality of pistons 52 received in the two second sub-channels 195 and the four third sub-channels 197. An area of the second supporting member 74 can be two times of an area of the first supporting member 72. Such that, the pressure generated by the holding device 100 towards the hollow workpiece 200 can be equal everywhere, and the hollow workpiece 200 can be prevented from being deformed. In other embodiments, when the shape or the size of the hollow workpiece 200 is changed, the shape of the supporting assembly 70 can be changed according to the shape of the hollow workpiece 200, and an arrangement of the supporting assembly 70 can be changed according to an actual requirement.

In assembly, the sealing ring 34 can be sleeved on the plunger 32, the plunger 32 can be inserted into the receiving portion 1911, and an end of the pressing member 36 can be coupled to the plunger 32. The sealing members 54 can be sleeved on the corresponding pistons 52, and the plurality of pistons 52 can be inserted into each of the plurality of the first, second, and third sub-channels, respectively. The first and second supporting members can be arranged on the second sidewall 14 and the top surface 12, respectively. The fasteners 56 can be inserted through the corresponding first and second supporting members to be coupled with the corresponding pistons 52. Such that, the supporting assembly 70 can be secured to the main body 10. The main body 10 can be filled with substance, and the plugs 1711 can seal the draining holes 17.

In operation, the holding device 100 can be positioned in the hollow workpiece 200, and an external tool, such as a torque wrench can tighten the pressing member 36. The pressing member 36 can push the plunger 32 to press the substance in the substance channel 19. The pressure of the substance can grow higher and the pistons 52 can move away from the main channel 191. As a result, the supporting assembly 70 can move away from the main body 10 and close the inside surface of the hollow workpiece 200. The pressing member 36 can be kept tight until a torque of the external tool is at a pre-set value. As a result, the main body 10, the first supporting surface 721, and the second supporting surface 741 can resist against the inside surface of the hollow workpiece 200 and support the hollow workpiece 200. In order to remove the holding device 100 from the hollow workpiece 200, the pressing member 36 can be released out of the mounting hole 15; the pressure of the substance in the substance channel 19 can be lower than before. The piston assemblies 50 can drive the supporting assembly 70 to move back in the main body 10, and the main body 10, the first supporting surface 72, and the second supporting member 74 can move away from the inside surface of the hollow workpiece 200. Such that, the holding device 100 can be removed from the hollow workpiece 200.

In an alternative embodiment, a shape of the main body 10 can be other shapes, not limited to, a column. Similarly, the shapes of the first and second supporting surfaces can be other shapes, not limited to, a column or a part of a column, but can be according to the shape of the hollow workpiece 200. Such that, the main body 10 can cooperate with the first and second supporting surfaces to resist against the inside surfaces of the hollow workpiece 200.

In an alternative embodiment, the end of each draining hole 17 extending through the first surface can be wholly received in the main body 10 and not communicate with outside. Accordingly, the plug 1711 can be omitted. Such that, the draining hole 17 can be divided into the draining end 171 and the extending end 173.

In an alternative embodiment, the substance channel 19 can be other cavities, such as, but not limited to, a columnar cavity, a cubic cavity, or other anomalistic cavities. Accordingly, the first, second, and third sub-channels can be omitted, such that, a plurality of holes communicating with the cavity receiving the piston assemblies 50 can be defined in the main body 10.

The embodiments shown and described above are only examples. Many details are often found in the art such as the other features of a piston. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

1. A holding device configured to hold a workpiece, the holding device comprising:
a main body defining a substance channel configured to contain a substance;
a supporting assembly configured to be movably coupled to the main body,
a plurality of pistons configured to move within a cylinder formed within the main body, wherein a first end of each piston is configured to be slidably received in the substance channel, and a second end of each piston opposite the first end is configured to be coupled to the supporting assembly; and
an adjusting assembly coupled to the main body to seal the substance channel, wherein the adjusting assembly is configured to be inserted into the substance channel to drive the plurality of pistons away from the main body in responds to induced motion of the substance there by causing the supporting assembly to press against an inside of the hollow workpiece, thereby holding the workpiece.

2. The holding device of claim 1, wherein the substance channel comprises a main channel and a plurality of first sub-channels; the main channel comprises a receiving portion and a draining portion; an end of the receiving portion liquidly communicates with an outer space, the other end liquidly communicates with the draining portion; the adjusting assembly is positioned in the receiving portion , each of the plurality of the first sub-channels can be spaced from each other; an end of each of the plurality of the first sub-channels liquidly communicates with the draining portion, the other end liquidly communicates with outside; each piston is positioned in a corresponding first sub-channel.

3. The holding device of claim 2, wherein the main body defines at least a draining hole crossing the draining portion, the draining hole is divided in to a draining end and an extending end extending from the draining portion.

4. The holding device of claim 3, wherein the supporting assembly comprises a first supporting member parallel to the main body and configured to be coupled to the pistons received in the first sub-channels; the first supporting member comprises a first supporting surface departing from the main body, and configured to resists against the inside of the hollow workpiece.

5. The holding device of claim 4, wherein the substance channel further comprises a plurality of second sub-channels ; each of the plurality of the second sub-channels is spaced from each other, axes of the second sub-channels is perpendicular to the axis of the draining portion and axes of the first sub-channels; an end of each of the plurality of the second sub-channels liquidly communicates with the draining portion, the other end extends through the main body and liquidly communicates with outside.

6. The holding device of claim 5, wherein the substance channel further comprises at least one third sub-channels spaced from each other and parallel to each other; axes of the at least one third sub-channels can be parallel to the axes of the second sub-channels; the at least one of the third sub-channels extends from the draining end through the main body and communicates with outside, and other third sub-channels extends from the extending end through the main body and communicate with outside, each of the plurality of the second sub-channels and each third sub-channel is configured to receiving a corresponding pistons.

7. The holding device of claim 6, wherein the supporting assembly further comprises a second supporting member, the second supporting member is parallel to the main body and corresponding to the second sub-channels and the third sub-channels, and the second supporting member is configured to be coupled to the corresponding pistons received in the second sub-channels and the third sub-channels.

8. The holding device of claim 2, wherein the main body comprises an end face and defines a mounting hole on the end face; an end of the mounting hole liquidly communicates with the receiving portion, the other end liquidly communicates with outside; the adjusting assembly is positioned in the mounting hole.

9. The holding device of claim 8, wherein the adjusting assembly comprises a plunger, a sealing ring sleeved on the plunger, and a pressing member coupled to the plunger; an end of the plunger is received in the receiving portioned, the other end protrudes into the mounting hole.

10. The holding device of claim 9, wherein a connecting portion is positioned in the mounting hole configured to be coupled to the pressing member.

11. The holding device of claim 10, wherein the connecting portion is a thread connecting member; a connecting thread is positioned on an end of the pressing member away from the plunger and configured to be coupled to the connecting portion.

12. The holding device of claim 1, wherein the substance contained in the substance channel is liquid.

13. The holding device of claim 1, further comprises a plurality of sealing members sleeved on the plurality of pistons, respectively, and a plurality of fasteners inserting through the supporting assembly to be coupled to the plurality of pistons , respectively.

14. A holding device, comprising:
a main body defining a substance channel;
a supporting assembly configured to be coupled to the main body,
a plurality of pistons configured to be movably positioned on the main body, a first end of each piston configured to be slidably received in the substance channel, a second end of each piston opposite the first end configured to be coupled to the supporting assembly, and
an adjusting assembly coupled to the main body to seal the substance channel, wherein the adjusting assembly is configured to be inserted into the substance channel, the plurality of pistons are configured to drive the supporting assembly away from the main body.

15. The holding device of claim 14, wherein the supporting assembly comprises a first supporting member parallel to the main body and configured to be coupled to some of the plurality of pistons received in the substance channel; the first supporting member comprises a first supporting surface departing from the main body.

16. The holding device of claim 15, wherein the supporting assembly further comprises a second supporting member parallel to the main body and configured to be coupled to the other pistons received in the substance channel.

17. A holding device, comprising:
a main body defining a substance channel, the substance channel comprising a main channel and a plurality of first sub-channels extending a side of the main channel ;
a supporting assembly configured to be coupled to the main body,
a plurality of pistons configured to be movably positioned on the main body, a first end of each piston configured to be slidably received in a corresponding first sub-channel, a second end of each piston configured to be coupled to the supporting assembly, and
an adjusting assembly received in an end of the main channel, wherein, the adjusting assembly is configured to move along the main channel, the plurality of pistons are configured to drive the supporting assembly to move away from the may body.

18. The holding device of claim 17, wherein the main channel comprises a receiving portion and a draining portion; an end of the receiving portion liquidly communicates with outside, the other end liquidly communicates with the draining portion; the adjusting assembly is positioned in the receiving portion , each of the plurality of the first sub-channels can be spaced from each other; an end of each of the plurality of the first sub-channels liquidly communicates with the draining portion, the other end liquidly communicates with outside.

19. The holding device of claim 17, wherein the main body defines at least one draining hole crossing the draining portion, the at least one draining hole configured to be divided into a draining end and an extending end by the draining portion.

20. The holding device of claim 19, wherein the supporting assembly comprises a first supporting member parallel to the main body and coupled to the pistons received in the first sub-channels; the first supporting member comprises a first supporting surface departing from the main body, and is configured to resists against the inside of the hollow workpiece via the first supporting surface.
